(19) United States
(12) Patent Application Publication
(10) Pub. No.: US 2011/0183531 A1
(43) Pub. Date: Jul. 28, 2011

(54) JUNCTION BOX FOR PHOTOVOLTAIC MODULES

(75) Inventors: Bastian Hornung, Ifta (DE); Klaus Liebrich, Viernau (DE)

(73) Assignee: Anton Gensler GmbH, Steinbach-Hallenberg (DE)

(21) Appl. No.: 12/737,129

(22) PCT Filed: Jun. 5, 2009
(86) PCT No.: PCT/EP2009/056941

§ 371 Date: Mar. 31, 2011

(30) Foreign Application Priority Data
Jun. 12, 2008 (DE) 10 2008 028 038.0
Nov. 13, 2008 (DE) 10 2008 057 078.8

(51) Int. Cl. H01R 12/71

(52) U.S. Cl. 439/76.1

(57) ABSTRACT

The invention relates to a junction box for photovoltaic modules, comprising prefabricated terminal cables that are electrically connected to a punched grid which has a strip conductor structure accommodating electrical or electronic components, in particular bypass diodes. The punched grid also has bent sections pointing in a direction which deviates from the plane of the punched grid. Contact means of the photovoltaic module engage into openings that are provided in the box member and point in said direction. According to the invention, the bent sections are designed as lyre contact bridges or omega contact bridges which have two opposite legs expanding in the direction of the module and a clamping part. The legs accommodate the contact means in a guided manner while the clamping part contacts the contact means. Furthermore, the box member is designed as a closed injection-molded piece except for the openings pointing in the direction of the module.

The invention relates to a junction box for photovoltaic modules, comprising pre-assembled connection cables that are electrically connected to a punched grid, the punched grid having a strip conductor structure which receives electric or electronic components, in particular bypass diodes, further comprising sections provided on the punched grid and oriented in a direction that deviates from the punched grid plane, wherein orifices are provided in the box body in this oriented direction into which contact means of the photovoltaic module engage, according to the preamble of patent claim 1.

A connection unit for photovoltaic solar modules is known from WO 2006/050890.

This connection unit for photovoltaic solar modules is provided with openly disposed connector sections of the strip conductor. According to this solution a connection unit is to be provided which can be connected without problems quickly at the photovoltaic solar module and wherein individual parts can be exchanged in a simple manner.

According to this invention the solar module is provided with openly disposed connector sections of the strip conductors. The actual connection unit is comprised of a base body and at least one slide-in housing part as well as of internally disposed electrical contacts and device elements. The connection unit is disposed sealingly immediately at the surface of the solar module. The base body possesses a recess, wherein internal electrical contact elements are constructed such, arranged such and positioned such that they can be contacted with a slide-in housing and the individual parts thereof and/or the conductors of the connection cable through plug connections. These contact elements form a circuit together with a switching and control unit within the slide-in housing part. The contacting of the electrical contact elements is disposed in a plane with the support face on the conductor track of the solar module. The connection unit serves for energy discharge out of the photovoltaic solar module to consumers and for the protection and the lifetime extension of the electrical contacts and connections of the internally disposed electronic device components.

The electrical connection of such a connection unit is complicated. Also the necessary access opening from the upper side of the unit does not allow an adequate tightness over the expected service life of 20 and more years.

A junction box for a solar panel is already known from the German Utility Model DE 20 2005 018 884 U1. The junction box comprises a housing in which connection means are provided for electrically connecting the solar panel. Moreover, diodes are disposed in the housing, which are electrically connected to the connection means. The diodes are designed as components provided with the lead wires. The connection means comprise a plurality of metallic contact elements disposed next to each other. The contact elements are designed as large-surface clamping parts made from sheet metal. The diodes are each connected and fixed by means of their lead wires between two clamping parts in a clamped fashion. Due to the necessity of the individual clamp-contacting processes for each diode the work involved by the production and the efforts necessary for completing the junction box are considerable, and there is the risk of a wrong interconnection caused by a wrong allocation of contacts. Also, the prior junction box requires a lid that can be swung open, which ensures the access to the contacting means. However, each solution of a junction box comprising a lid leads to inevitable tightness problems.

A panel-like electrical/electronic module having a flat surface with openly contactable connecting sections as part of an essentially flat printed conductor structure for the electrical connection of the module is already known from the generic EP 1 442 503 B1.

According to the requirement that solar power modules must be resistant to wind and weather to ensure their use over a period of 25 years, all electrical junctions have to be protected from moisture penetration. This protection is also required for the necessary diodes. According to EP 1 442 503 B1 the problem is to be overcome to carry out the necessary electrical connections between a connection unit and the solar module not only by using simpler means, but also by mechanical means. In order to overcome this problem it is proposed that the means for contacting the connecting sections of the module are bent out from the plane of the printed conductor structure, and a portion of the connecting sections representing the printed conductor structure and the connecting sections of the module are rigid electrical conductor sections which can be bent out of the plane of the printed conductor structure of the module, the connecting sections of the connection unit being situated corresponding to the arrangement of the connecting sections of the module, so that for the connection unit connected to the module, each connecting section of the module is electrically connected to the respective connecting section of the connection unit and these adjoin one another in one section. Accordingly, the connection unit includes a printed conductor structure in the form of a punched grid, and the connecting sections of the printed conductor structure of the connection unit provided for contacting the connecting sections of the module are a part of the punched grid. Situated on this punched grid are the necessary electrical/electronic components, such as diodes, and at least one connecting cable joined to the punched grid by a jointed connection.

The punched grid is encapsulated by a casting body, using an injection-molding process. In the method for connecting the connection unit to the solar module the connection unit is first positioned on the module so that the corresponding connecting sections are placed next to each other. Then, the connecting sections of the module have to be grasped and lifted from the surface of the module. In the next step the connecting sections of the module are joined with the connecting sections of the connection unit so that the connection units are subsequently situated in another spatial position. The non-accessible surfaces of the connecting sections of the module that were initially situated at the bottom are now freely accessible for carrying out a jointed connection in order to connect one connecting section of the module to a connecting section of the connection unit. The connection of the respective connecting section pairs is then accomplished by means of jointing, specifically by welding.

From the description of the contacting method it becomes obvious that a number of steps are required for producing an adequate and reliable electrical connection. Moreover, the prior solar module needs to remain freely accessible from its upper side as otherwise the necessary welded/jointed connection cannot be realized. This open section has to be sealed again later with all above-described disadvantages.

Based on the foregoing it is therefore the object of the invention to provide a further developed junction box for photovoltaic modules, which can be pre-assembled to a greatest possible degree and which only has minimal orifices or windows, namely in such a form that is absolutely necessary to allow a contacting with the contact means of the photovoltaic module.

The solution to the object of the invention is achieved with a junction box according to the combination of features defined in patent claim 1. The dependent claims define at least useful embodiments and advancements. Accordingly, there is provided a junction box for photovoltaic modules, comprising pre-assembled connection cables that are electrically connected to a punched grid, the punched grid having a strip conductor structure which can receive electric or electronic components, in particular bypass diodes. Moreover, sections or bending sections are provided on the punched grid which are oriented, e.g. bent, in a direction that deviates from the punched grid plane, wherein orifices or windows are provided in the box body in this oriented direction into which contact means known per se of the photovoltaic module, so-called ribbon contacts, engage. In another embodiment special sections may be provided on the punched grid that comprise or are designed as lyre or omega contact clips. These sections can be fixed to the punched grid, for example, by material bonding or also by a frictional connection, e.g. by riveting.

According to the invention the integral sections or the bending sections are designed as lyre or omega contact clips comprising two opposite legs, that expand in the direction of the solar module, as well as a clamping part. The contact means of the photovoltaic module are received by the legs in a guided manner and are contacted by the clamping part. Moreover, except for the orifices pointing in the direction of the module, the box body is constructed as a completely closed injection-molded part without any other accesses.

According to a first preferred embodiment of the invention the punched grid is made of a metallic material which, if necessary, is surface-finished, wherein the legs of the contact clips are formed by bending them out of the surface plane of the grid.

According to a second embodiment the punched grid is formed of a plane part, wherein the legs of the contact clips project out of the surface plane of the grid, while the legs are produced as a separate part, however, and are connected to the punched grid.

At the narrowest point of the opposite legs of the contact clips a defined distance is provided which is subject to tolerances. The dimension of the distance results from the thickness dimensions of the contact means of the photovoltaic module.

After electrically connecting or contacting the connection cables with provided sections of the strip conductor structure a pre-molded part is produced. Then, in a next injection molding step, the pre-molded part is surrounded by a design-determining contour body. According to the invention it is possible to produce customer-specific, i.e. design-oriented contour bodies from a quasi standard pre-molded part, so that different junction boxes are realized as far as their outer appearance is concerned.

According to a first modification it is basically possible to connect the punched grid to the connection cable and produce the pre-molded part subsequently. Alternatively it is possible that the punched grid is provided with a pre-molded part, and the connection cables are contacted at the free ends of the punched grid then available.

Incorporated details about the type specification, the producer, the use or the like may be provided at or on the contour body.

Parts of the strip conductor structure are constructed to be separable. The separation may be carried out on the pre-molded part.

According to the invention the electric or electronic components are arranged on the strip conductor structure preferably in the space around or between the lyre or omega contact clips. By this the installation space and the spatial volume of the entire junction box can be minimized.

The contact means of the respective photovoltaic module are connected to the lyre or omega contact clips exclusively by material bonding and/or a frictional connection. Any additional connections obtained by material bonding, e.g. soldering or welding, requiring access to the contacts are not necessary.

The finished box body is fixed with the orifices for the access to the contact clips in the direction towards the photovoltaic module on the photovoltaic module by material bonding, specifically by using an adhesive. On the upper side, and also on the side faces, the box body is completely sealed so that the penetration of moisture into the interior of the box is rendered more difficult. The orifices in the box body are formed as window-like cavities, with the window dimensions being basically minimized without restricting or obstructing the movement of the contact clips during the contacting process. It is the aim to maximize the adhesive surface, and thus the sealing surface, on the bottom side of the box, on the one hand, in order to guarantee a secure fixation of the junction box on the solar module and, on the other hand, to ensure the required tightness during the desired long service life.

In order to dissipate the heat generated by the diodes without having to provide ventilation channels in the box body it is provided by the invention that the injection molding material is partially or completely thermally conductive. It is possible to add a defined quantity of metal oxides, e.g. Al₂O₃, to the injection molding starting material so as to allow the thermal conduction out of the interior of the box body whilst not jeopardizing the electrical insulation. Another noteworthy aspect of the invention in this regard is maximizing the material quantity of the punched part with respect to the heat dissipation effect. The metallic material of the punched part then serves as a heat sink with respect to the bypass diodes representing the heat source.

According to another aspect of the present teaching the connection cables and lines are coated in a material-bonded manner in order to obtain the required service life of photovoltaic systems, namely for the purpose of realizing a high tightness over the whole service life. However, if a cable is already provided with a cured plastic material a material-bonded coating of the cable may be problematical because the combined polymer chains of the cured lines do not allow an adequate bond with the plastic coating material. It has surprisingly shown that this problem can be solved by a pretreatment of the lines so as to obtain the desired material bond with selected plastic materials. Specifically, this pretreatment is a treatment based on the influence of electric fields and/or corona discharges.

The invention shall be explained in more detail below by means of an embodiment and with the aid of figures.

In the drawings:

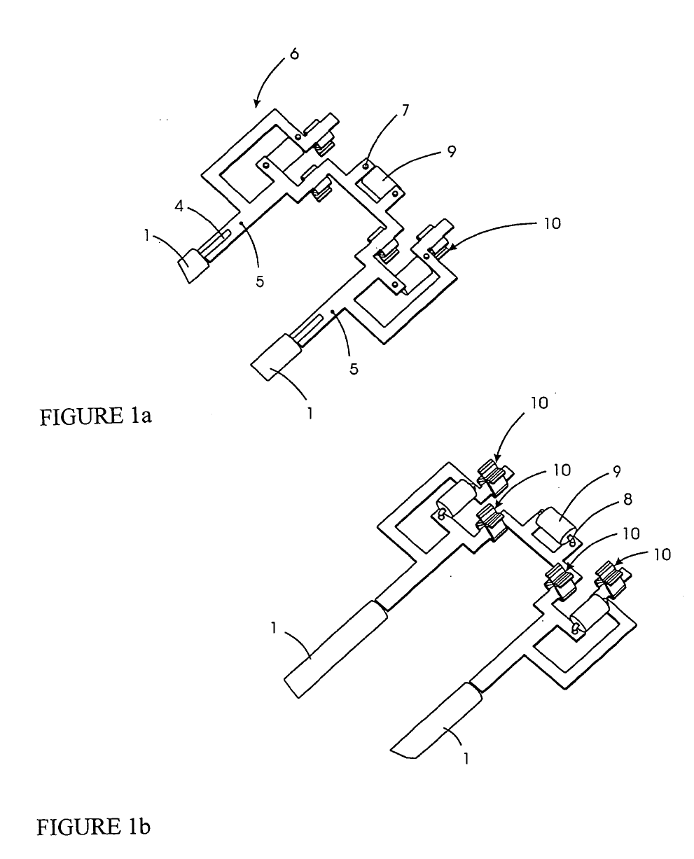

FIG. 1a, b show a detailed view of a punched grid from the bottom side (upper representation) and the top side (lower representation) in a first embodiment;

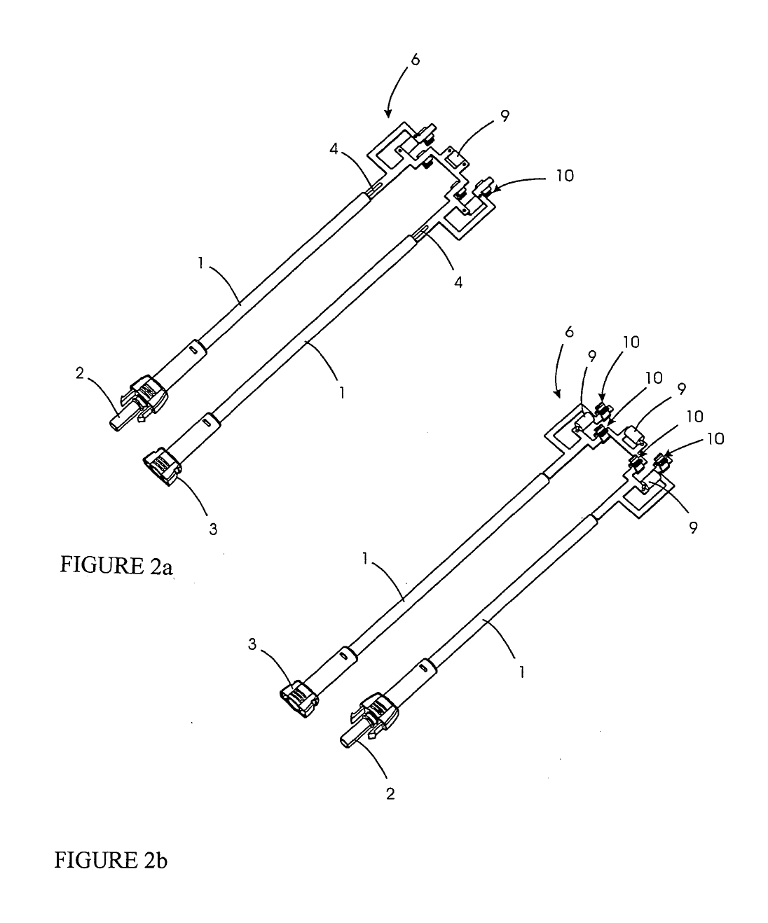

FIG. 2a, b show representations of the complete punched grid with already electrically connected pre-assembled connection cables in a top and bottom view (first embodiment);

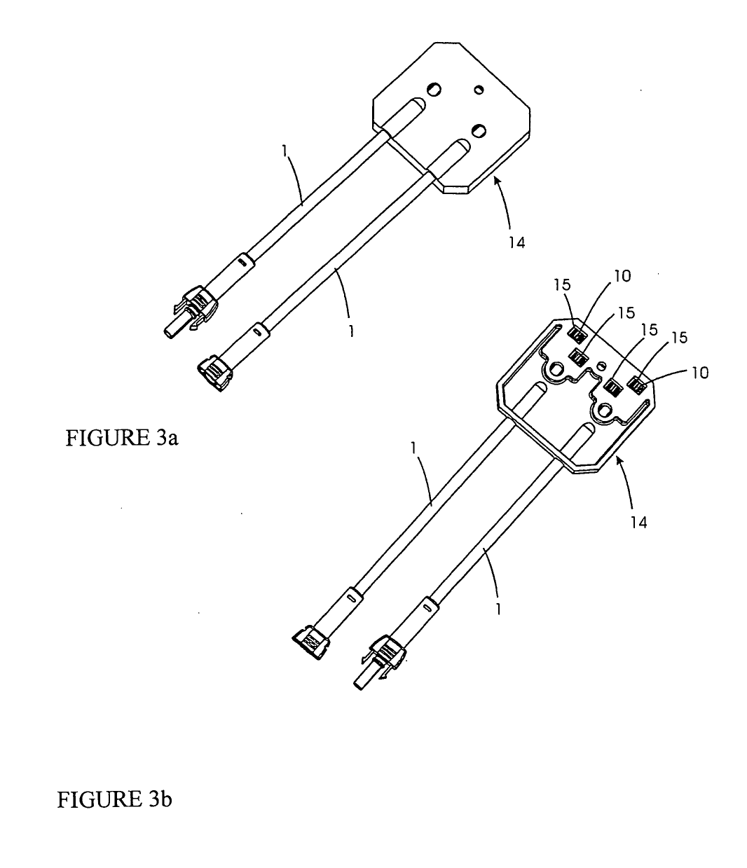

FIG. 3a, b show a view of the complete pre-molded part from the top and the bottom, with the windows and the contact clips located therein being recognizable in the lower representation;

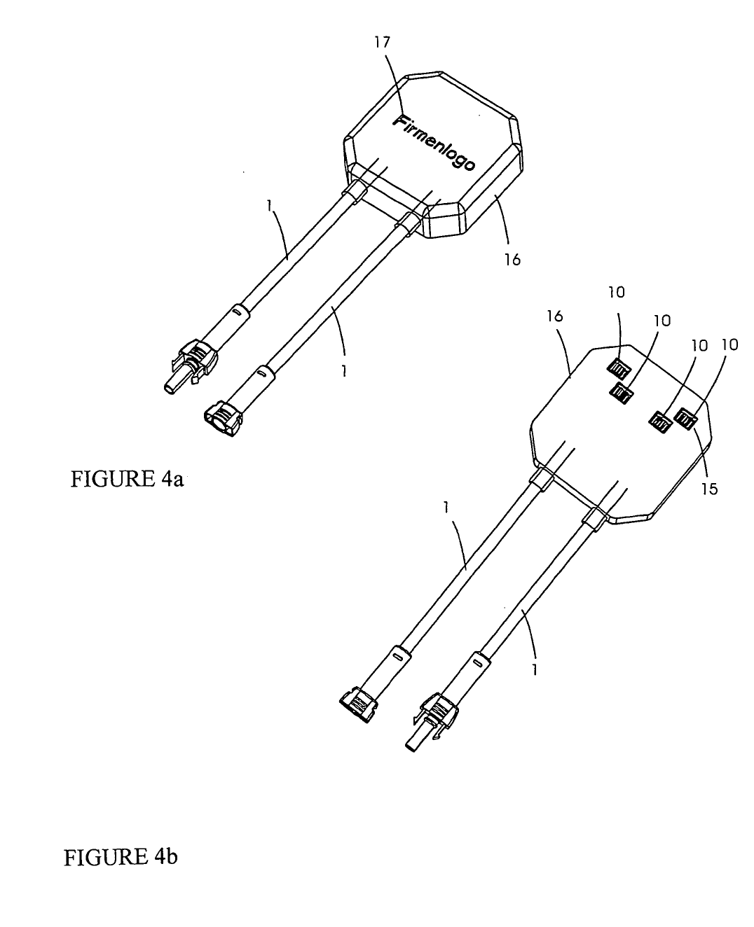

FIG. 4a, b show a top view and a bottom view of the complete junction box with a contour body produced in a second injection molding step;

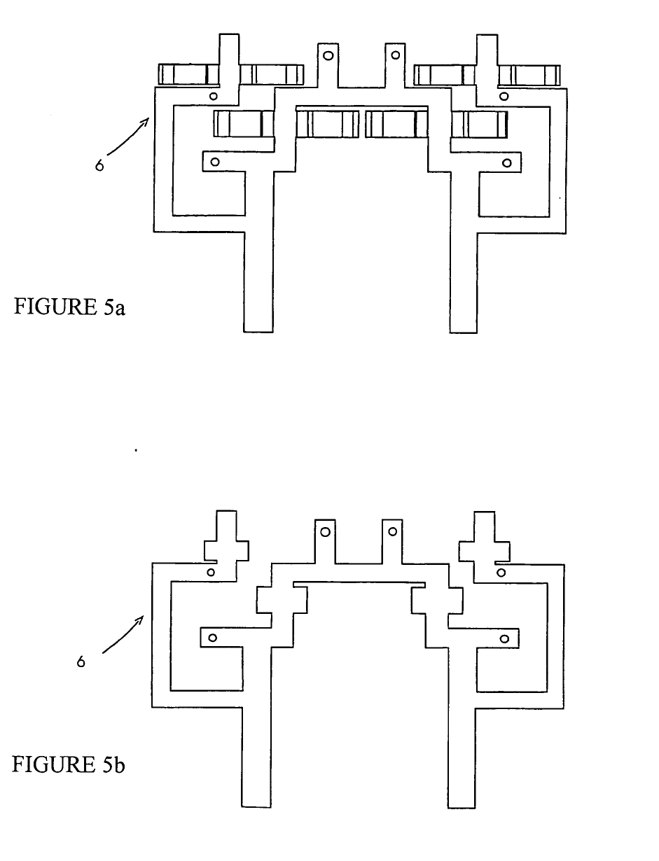

FIG. 5a shows a development of the punched grid;

FIG. 5b shows a representation of the bottom side of the punched grid with lyre or omega contact clips already produced by bending;

FIG. 5c shows a lateral view of the representation according to FIG. 5b;

FIG. 5d shows a detailed representation Z according to FIG. 5c with the recognizable omega contour of the respective contact clip;

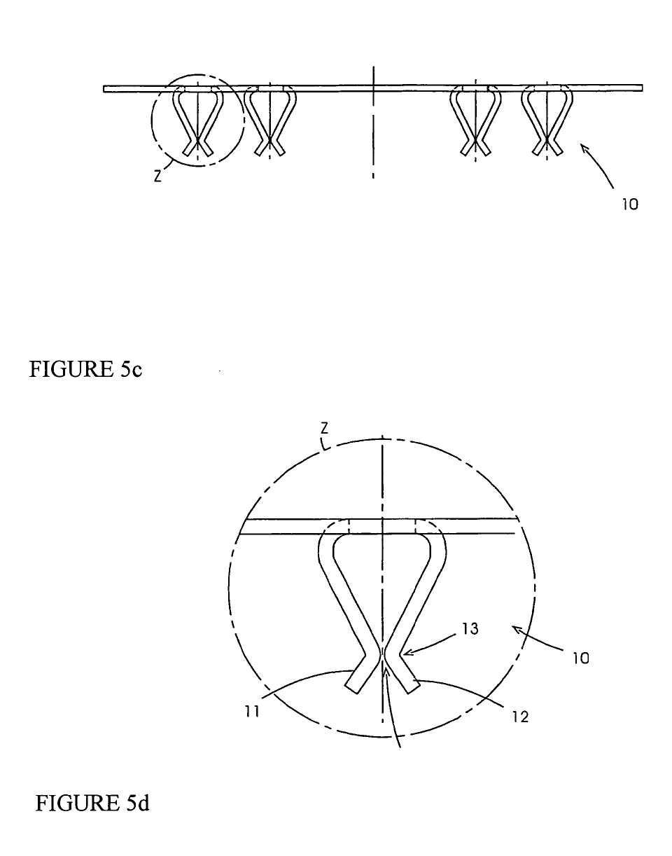

FIG. 6a, b show a detailed view of the punched grid from the top side (upper representation) and the bottom side (lower representation) in a second embodiment;

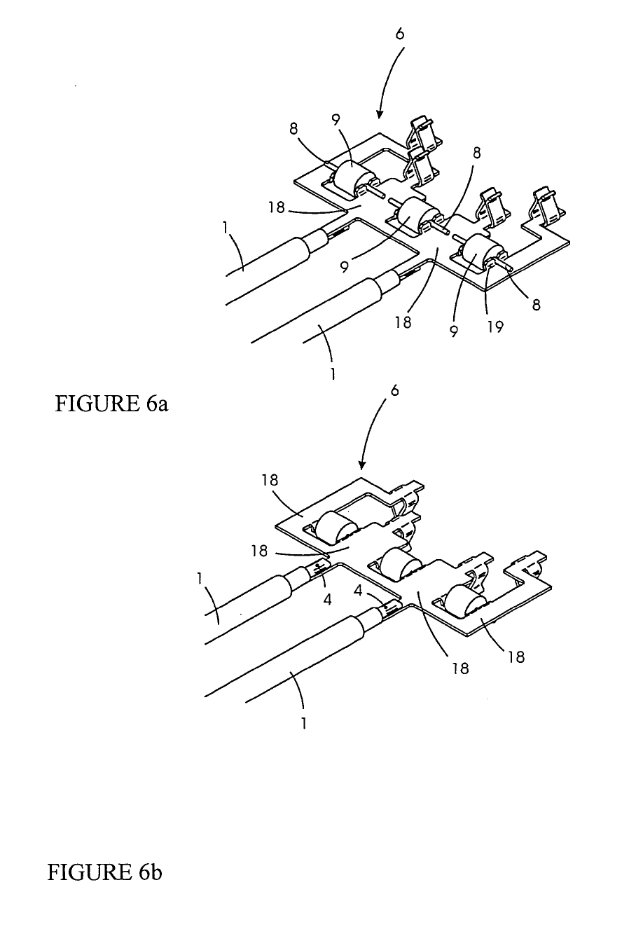

FIG. 7a, b show representations of the complete punched grid of the second embodiment with already electrically connected pre-assembled connection cables in a top and bottom view;

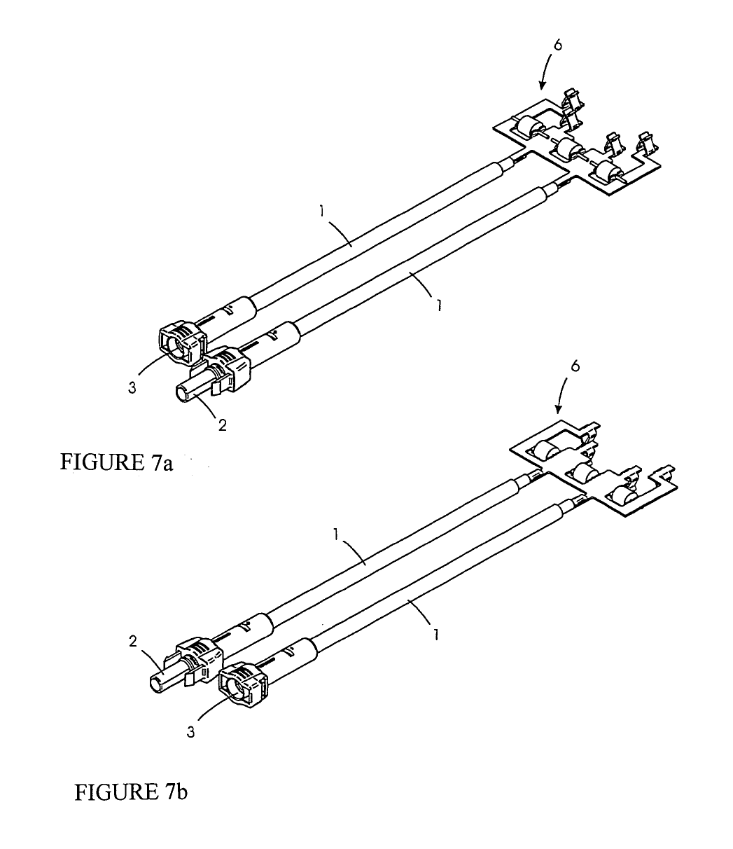

FIG. 8a, b show a view of the complete pre-molded part from the top and the bottom according to the modification of the second embodiment, with window-like cavities and contact clips located therein being recognizable in the upper representation;

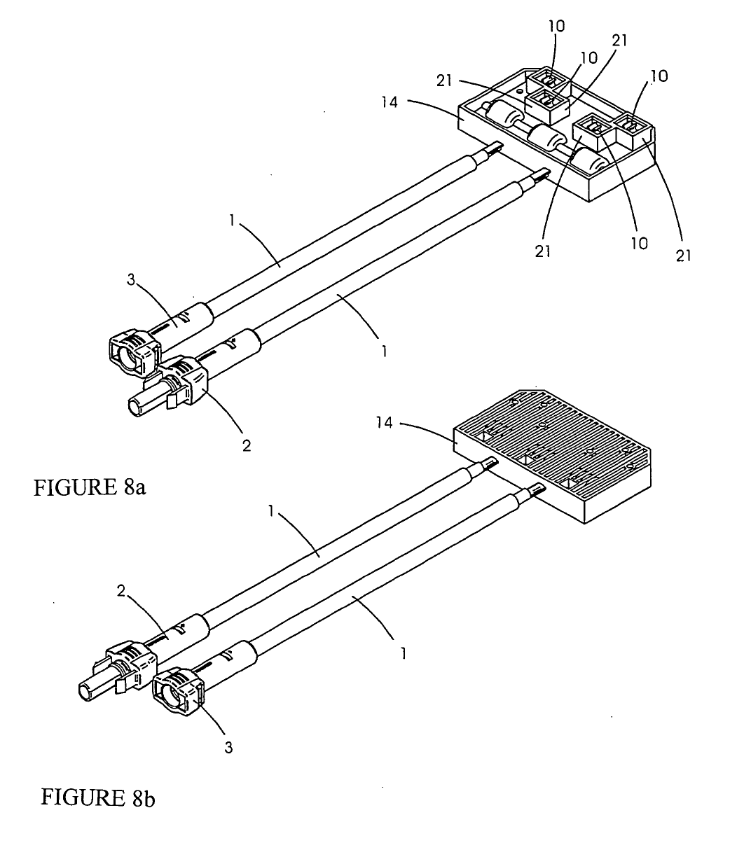

FIG. 9a, b show a bottom view (upper representation) and a top view (lower representation) of the complete junction box, which is produced in a second injection molding step and forms a contour body;

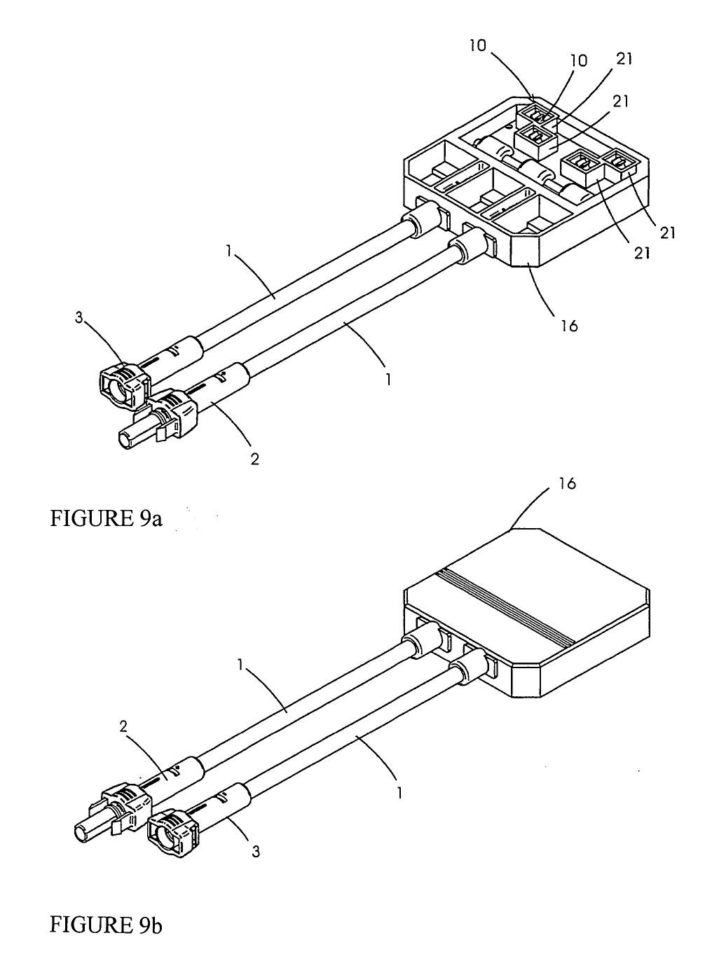

FIG. 10a shows a development of the punched grid of the second embodiment;

FIG. 10b shows a representation of the bottom side of the punched grid with lyre or omega contact clips already produced by bending and with erect tongues for fixing the connection pins of bypass diodes according to the second embodiment of the invention;

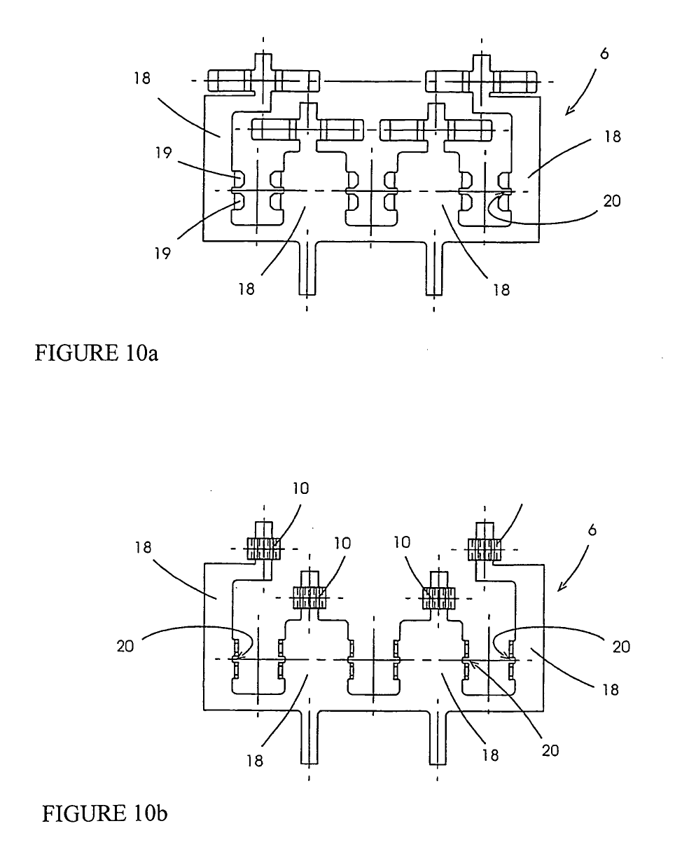

FIG. 11 shows a lateral representation of the punched grid as shown in FIG. 10b; and

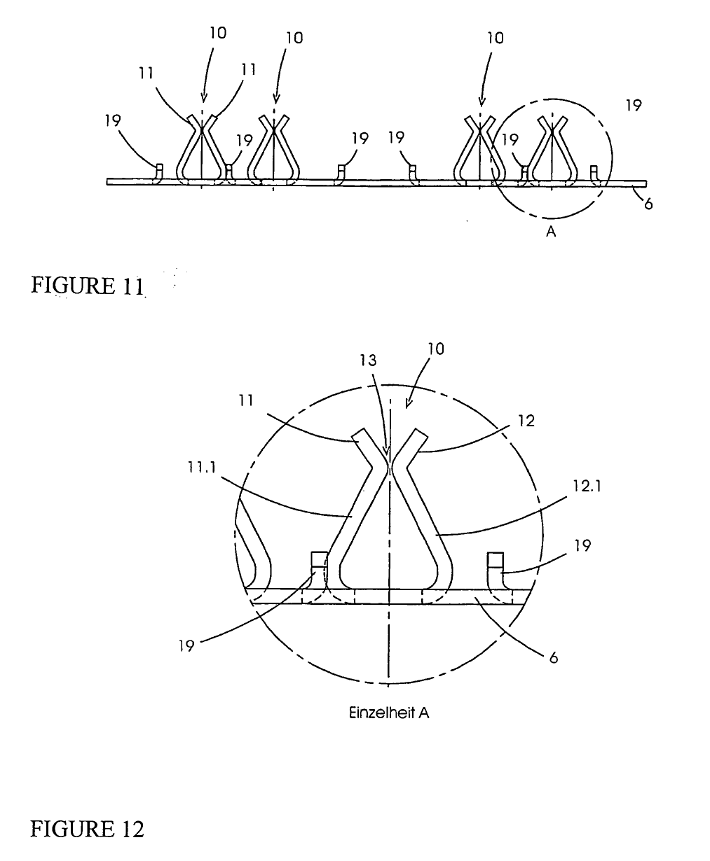

FIG. 12 shows a detailed representation A of an exemplary lyre contact clip.

The inventive junction box for photovoltaic modules according to the figures comprises pre-assembled connections cables 1 which are provided with reverse polarity protected male connectors 2 and female connectors 3.

The connection cables 1 are connected by stripped ends 4 to surface sections 5 of the strip conductor structure 6 of the punched grid, preferably by material bonding, e.g. soldering or welding, or by a frictional connection, e.g. crimping.

The strip conductor structure includes punchings 7 which receive the connection pins 8 of electric components 9. The connection pins 8 are soldered or welded to the punchings 7 in order to produce a secure connection.

Prior to carrying out the injection molding process, after the separation, the unit according to FIG. 1 or 2 can be electrically tested and, if necessary, made operative by exchange or reworking. The separation may also be accomplished after the production of the pre-molded part, however.

The punched grid comprises integral or bending sections in the form of lyre or omega contact clips 10. The punched grid may also comprise separately fabricated bending sections in the form of lyre or omega contact clips, however. In this case the separate parts are connected to the punched grid, e.g. by material bonding such as welding, or by a frictional connection, e.g. by riveting.

The shape of the contact clips is shown in the representations according to FIGS. 5a to 5d.

The respective lyre or omega contact clips each have two opposite legs 11, 12 expanding in the direction of the module.

These legs 11, 12 are adjoined by a clamping part or a clamping section 13.

When producing the connection to the contact means of the photovoltaic module, in particular a so-called contact ribbon, this contact means is received by the legs 11, 12 in a guided manner and is introduced into the clamping part or clamping section 13 where it is held by a material bond and/or frictional connection. The lyre or omega shape of the contact clips 10 ensures an adequate spring force and, thus, contact force.

The production of the punched grid with the lyre or omega contact clips 10 may be accomplished in a very simple and cost-efficient manner.

The material of the punched grid is made, for example, of a galvanically coated and thus surface-finished metallic material. In order to ensure the solderability of the stripped ends 4 of the connection cables 1 they may be subjected to tinning.

The punched grid assembly according to FIG. 2, completed with the connection cables 1, is processed further to obtain a pre-molded part according to FIG. 3. This exemplary pre-molded part already includes window sections 15, in which the lyre or omega contact clips 10 are exposed, on its bottom side that later faces the solar module.

In another injection molding step, the result of which is shown in FIG. 4, a design-determining contour body 16 is produced. This contour body 16 closes the areas of the pre-molded part 14 that, according to FIG. 3, are still open.

It can be seen from the proportions shown in the view of the bottom side of the junction box according to FIG. 4 that a very large, plane bottom surface is available, which may be used for connecting it to the solar module by means of material bonding. The sizes of the windows 15 are only insignificantly larger than the space occupied by the contact clips 10, which represents an important advantage with respect to sealing purposes.

Particularly on the upper side the contour body 16 may include incorporated details such as details about the producer or the like information 17.

The second embodiment of the invention shall be explained in more detail by means of FIGS. 6 to 12.

In this embodiment, too, a strip conductor structure in the form of a punched grid 6 is provided (in FIGS. 6 and 7 the bridge sections between the diodes or the electronic components 9 have not yet been separated).

In order to obtain an effective heat sink for the diodes 9 or other heat-generating electronic components the strip conductor structure has sections with an enlarged metallic surface.

Preferably, these sections 18 are located near the heat sources, i.e. the electronic components 9.

In the representation according to FIG. 6 the connection pins 8 of the components 9 are not bent, but shortened to a defined size. The connection pins 8 rest in tongue- or finger-type prolongations 19 which were bent out of the plane of the punched grid, i.e. the strip conductor structure 6, and spare a slot for receiving the respective connection pins 8. This detail is once more illustrated in FIGS. 10a and 10b.

The slot for receiving the connection pins 8 is identified by reference number 20.

FIG. 7 shows the assembly of the punched grid, completed with connection cables 1. The cables 1 are already provided with contact means at their ends, i.e. male connector 2 and female connector 3.

FIG. 8 illustrates the result represented by a pre-molded part 14.

The lyre or omega contact clips 10 are each surrounded by a frame 21 defining a window in its center in which the contact clips 10 can move.

During the preliminary injection molding process also the electronic components 9 (bypass diodes) are coated, namely with a thermally conducting material, so that the heat lost during the operation can be dissipated.

In the second embodiment, too, a design-determining contour body 16 is produced in a further injection molding step, the result of which is shown in FIG. 9. This contour body 16 (bottom view in the upper representation of FIG. 9) includes air spaces so as to optimize the heat dissipation of the electronic components. However, irrespective of the air spaces, all other elements important for the function are sealed.

The statements made with respect to the construction of the windows 15 of the first embodiment apply analogously to the second embodiment of the invention, so that the same advantages are obtained.

FIG. 10a shows the development of the strip conductor structure 6 or punched grid, respectively (not yet separated in an electrically relevant manner). In this development the punched out prolongations 19 are well recognizable, which are each located opposite in pairs and receive a slot 20 nearly in the center.

The slot 20 serves to fix a corresponding connection pin 8 of an electronic component 9, specifically a bypass diode.

The lyre or omega contact clips 10, which are shown in detail in FIGS. 11 and 12 of the embodiment according to the second example, comprise two opposite legs 11 and 12.

In the representation according to FIG. 12 (detail A) the legs 11 and 12 open upwardly in a V-shaped manner. A clamping section 13 is formed between the narrow point between the legs 11 and 12.

When producing the connection to the contact means of the photovoltaic module, in particular a contact ribbon or contact strip provided there, this part is received by the legs 11 and 12 in a guided manner and is introduced into the clamping section 13, where it is held by a material bond and/or frictional connection.

The shape of the contact clips 10 ensures an adequate spring force and, thus, contact force for a long operating time and service life.

As can be seen from the synopsis of FIGS. 5d and 12 the angle between the longer leg portions 11.1 and 12.1 is, for example, approximately 50° to 60°.

### LIST OF REFERENCE NUMBERS

1 cable
2 male connector
3 female connector
4 stripped end
5 surface section
6 strip conductor structure
7 punching
8 connection pin
9 electronic component
10 lyre or omega contact clip
11, 12 legs
11.1/12.1 leg portions
13 clamping part
14 pre-molded part
15 window
16 contour body
17 information detail
18 enlarged surface sections
19 prolongation
20 slot
21 frame

1. Junction box for photovoltaic modules, comprising pre-assembled connection cables (1) that are electrically connected to a punched grid, the punched grid having a strip conductor structure (6) which receives electric or electronic components (9), in particular bypass diodes, further comprising bending sections provided on the punched grid and oriented in a direction that deviates from the punched grid plane, wherein orifices are provided in the box body in this oriented direction into which contact means of the photovoltaic/nodule engage,
characterized in that
the integrally or separately formed bending sections are designed as lyre or omega contact clips (10) comprising two opposite legs (11, 12), that expand in the direction of the module, as well as a clamping part (13), wherein the contact means are received by the legs (11, 12) in a guided manner and are contacted by the clamping part (13), and wherein further, except for the orifices (15) pointing in the direction of the module, the box body is constructed as a closed injection-molded part.

2. Box according to claim 1,
characterized in that
the punched grid is made of a metallic material, wherein the legs (11, 12) of the contact clips (10) are formed by bending them out of the surface plane of the punched grid.

3. Box according to claim 1,
characterized in that
at the narrowest point of the opposite legs (11, 12) a defined distance is provided which is subject to tolerances.

4. Box according to claim 1,
characterized in that
before or after electrically connecting the connection cables (1) with provided sections (5) of the strip conductor structure (6) a pre-molded part (14) is produced.

5. Box according to claim 4,
characterized in that
the pre-molded part (14) is surrounded by a design-determining contour body (16).

6. Box according to claim 5,
characterized in that
the contour body (16) is also formed by injection molding.

7. Box according to claim 5,
characterized in that
incorporated details (17) about the type specification, the producer, the use or the like information are provided on the contour body (16).

8. Box according to claim 1,
characterized in that
parts of the strip conductor structure (6) are constructed to be separable.

9. Box according to claim 1,
characterized in that
the electric or electronic components (9) are preferably arranged on the strip conductor structure in the space between or around the lyre or omega contact clips (10).

10. Box according to claim 1
characterized in that
the contact means of the photovoltaic module are connected to the lyre or omega contact clips (10) exclusively by material bonding and/or frictional connection.

11. Box according to claim 1,
characterized in that
the box body can be fixed with the orifices (15) for the access to the contact clips (10) in the direction towards the photovoltaic module on the photovoltaic module by material bonding.

12. Box according to claim 1.
characterized in that
the orifices (15) in the box body are formed as window-like cavities, with the window dimensions being minimized without restricting or obstructing the movement of the contact clips (10) during the contacting process.

13. Box according to claim 2,
characterized in that
at the narrowest point of the opposite legs (11, 12) a defined distance is provided which is subject to tolerances.

14. Box according to claim 2,
characterized in that
before or after electrically connecting the connection cables (1) with provided sections (5) of the strip conductor structure (6) a pre-molded part (14) is produced.

15. Box according to claim 3,
characterized in that
before or after electrically connecting the connection cables (1) with provided sections (5) of the strip conductor structure (6) a pre-molded part (14) is produced.

16. Box according to claim 6,
characterized in that
incorporated details (17) about the type specification, the producer, the use or the like information are provided on the contour body (16).

17. Box according to claim 2,
characterized in that
parts of the strip conductor structure (6) are constructed to be separable.

18. Box according to claim 3,
characterized in that
parts of the strip conductor structure (6) are constructed to be separable.

19. Box according to claim 4,
characterized in that
parts of the strip conductor structure (6) are constructed to be separable.

20. Box according to claim 5,
characterized in that
parts of the strip conductor structure (6) are constructed to be separable.
